(19) United States
(12) Patent Application Publication
(10) Pub. No.: US 2022/0385020 A1
(43) Pub. Date: Dec. 1, 2022

(54) Perception Prediction Illumination Feedback

(71) Applicants: Matthew Creedican, Arlington, WA (US); Sohan Mikkilini, Boston, MA (US)

(72) Inventors: Matthew Creedican, Arlington, WA (US); Sohan Mikkilini, Boston, MA (US)

(21) Appl. No.: 17/824,853

(22) Filed: May 25, 2022

Related U.S. Application Data
(60) Provisional application No. 63/202,090, filed on May 27, 2021.

(51) Int. Cl. H01S 3/00; H01S 3/10

(52) U.S. Cl. CPC H01S 3/0071; H01S 3/10

(57) ABSTRACT

A system having a perception of its general environment is described. The general environment may include its surroundings, circuits, power supply, optics, emitters, software processing, and other things that may affect its perception system or sensors and biases associated with data processing. With this information, it may be able to adapt to the general environment with little human intervention. Dynamic updating and calibration of the environment or sensors in the environment may be provided. From one time frame to another, location or other information can be more efficiently rendered or decoded. Knowing the spacing of receivers may allow time delay calculations. Real world environmental changes may impact the relative location and or properties of these sensors. Observation or communication of these changes can be used to predict assembly and processing or projection of energies for a desired effect.

### FIELD

This disclosure generally relates to perception predication illumination feedback.

### BACKGROUND

Current energy projection systems such as lasers are generally designed with a single purpose. Usually, an operator has to consider many factors when setting up a laser or other projection system to accomplish a specific task. Or the system is designed to function in a narrow manner and cannot be easily modified to perform a wide variety of tasks or outputs.

### SUMMARY

A system having a perception of its general environment is described. The general environment may include its surroundings, circuits, power supply, optics, emitters, software processing, and other things that may affect its perception system or sensors and biases associated with data processing. With this information, it may be able to adapt to the general environment with little human intervention. Outputs may be derived from given inputs, which may allow a system to test outcomes from various situations. A modular system that can rapidly alter various parameters of emitters under its control may be able to test and verify various emission methods rapidly. It may also utilize emitters in more than one way in near real-time. It may also communicate with other sensors and systems like itself, which may allow it to utilize multiple emitters from multiple perspectives to illuminate targets in unique manners. The system may provide a rapidly adaptable architecture where a computer architecture can control emitters. Just as parameters for cameras, such as exposure time, aperture size lens, and focus, may be automatically controlled, emitters such as lasers may also be controlled for polarization, wavelength, intensity, focus, and other factors. The ability to rapidly perceive and adjust and test and adjust may allow rapid advancements in methodology and utilization of emitters such as lasers, lights, radio, masers, electron beams, and the like.

Microphone arrays and vibration/acoustic energies may be used.

For example, if multiple microphone arrays are used, and they can communicate to each other via sound waves, the analog of the arrival of the sound wave frequency and properties can be used to gain a relative understanding of one sensor to another. They may additionally communicate via acoustics or another means to pass information. By understanding the relative geometries and updating in near real time a dynamic calibration can be achieved. Using this understanding one can then calculate the position and relevance or other incoming signals.

### BRIEF DESCRIPTION OF THE DRAWINGS

FIG. 1 illustrates a block diagram of a PPIF Unit capable of supporting Perception Predication Illumination Feedback.

FIG. 2: illustrates a PPIF system interreacting a target and environment.

FIG. 3: illustrates a targeting and perception strategy.

### DETAILED DESCRIPTION

A more particular description of certain implementations of a platform may be had by references to the implementations shown in the drawings that form a part of this specification, in which like numerals represent like objects.

In this disclosure, where laser, maser, LIDAR, LADAR, or other forms of electromagnetic radiation (EM) is used, it may refer to any type of EM or other energy sources unless the context indicates a specific technology.

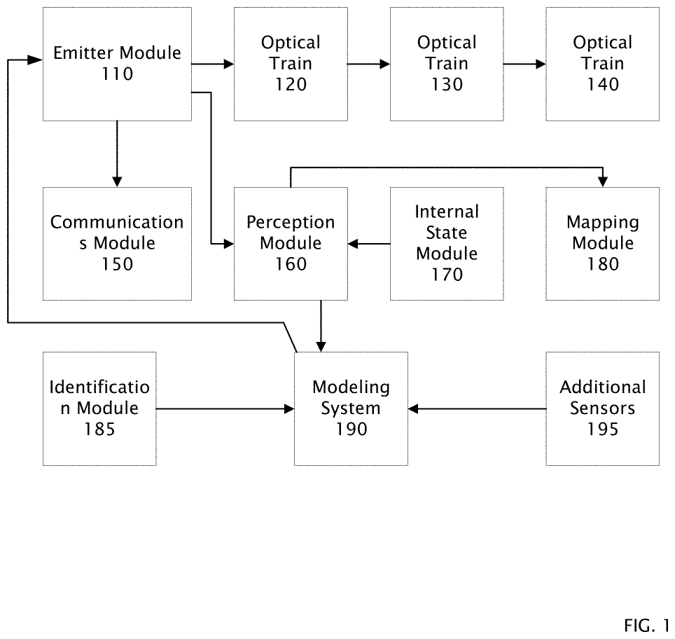

FIG. 1 illustrates a block diagram of PPIF Unit 100 capable of supporting Perception Predication Illumination Feedback.

Emitter Module 110 may include an adjustable wavelength laser, various wavelengths of visible light, either coherent laser or laser-like structured light, non-coherent light, RF, an electron beam, and sound. It may include a MEMS mirror, solid-state, or other steerable low mass mirror. It may also include solid-state photonics, metamaterials, or holographic photonics.

Optical Train 120 may allow changing a focus of any emitter technology used in Emitter Module 110.

Optical Train 130 may allow combining emitters pathing, possibly of differing wavelengths.

Optical Train 140 may allow additional focus adjustments.

Communications Module 150 may utilize Emitter Module 110, Wi-Fi, cellular data access methods, such as 3G or 4GLTE, Bluetooth, the Internet, local area networks, wide area networks, or any combination of these or other means of providing data transfer capabilities.

Perception Module 160 may include a camera, radar, or other sensors. It may include LIDAR scan protocol, a spinning laser, raster, spiral scan, or other scan and receive setup information to create a depth map or a point cloud. It may also include a feedback loop and sensors, such as a camera or photodetector, to track a laser's apparent intensity and position.

Internal State Module 170 may track position and orientation of a laser or other emitter, and sensor status.

Mapping Module 180 may provide mapping capabilities, which may be similar to Simultaneous Location and Mapping capabilities.

Identification Module 185 may track potential targets and environmental conditions.

Modeling System 190 may combine sensor data from standalone units, incorporate sensing information from common wireless communication modules, or even utilize its own laser and detector system to communicate with other systems. It may combine this information in a model and predict a point of aim of laser and other systems to achieve desired effects, which may, for example, be preset by the user. For example, it may shoot a laser directly into a kidnapper's eyes while also communicating with a second system to project a beam at an angle that will bounce into the kidnapper's eyes when they try and duck their head or shield their eyes from a direct impingement.

Similarly, combining and modeling may allow predictions for improving electronic warfare jamming of enemy sensor systems. For example, a cooperative reflector element such as a UAS with a mirror or antenna like body may reflector or deflect energy to a target.

Additional Sensors 195 or other modes of sensing may be incorporated to characterize the environment, the medium, or objects that the impingement mechanism from Emitter Module 110 may be interacting with, which may allow better aiming and predicting the aim of the emitter for the various uses stated.

Other sensors may relay information and, for example, communicate position and act as communication platforms. They may also degrade enemy observations using laser or other-directed energy transmissions and may be much more versatile and effective than current large systems mounted on vehicles that need to slew to a single target. A modular setup may allow multiple units that may perceive more area and cover many more angles. This may be especially valuable in any area where many obstacles block lines of vision or there are large numbers of adversaries. It may also be effective in the cost and power savings of smaller systems allowing more ubiquitous coverage of the environment. Precision-directed laser systems are also valuable in secure communications as only enough power is needed as absolutely necessary for very directed communications. Any reflections of this signal may be degraded so much that no useful signal can be detected.

Item or items that are well known may be used to calibrate sensors and emitters. This may include items in the environment that may be cross-referenced and inferred to be of a shape and properties that agree across time, space, and angles, so that the ratios are consistent. For example, if I have a “sight” such as the crosshairs on a rifle scope, and I put these over a target, the sight to the sensor will match known properties, and from this reference, I can then compare a target to the sight and get a ratio. If I know the distance through some measure, I may use this information to infer properties such as a size of objects nearby. If a laser is fired at this point, the laser divergence and shape may be compared with that of the object and the sight, which may allow the characterization of function of the laser.

This system does not need to be constrained to disabling and disrupting enemy systems. Precision rapid aiming elements in small modular packages that may be combined to cover 360 degrees plus multiple angles may be useful in communications, display and targeting applications, and additional sensing such as utilization in LIDAR and laser microphone systems, for example.

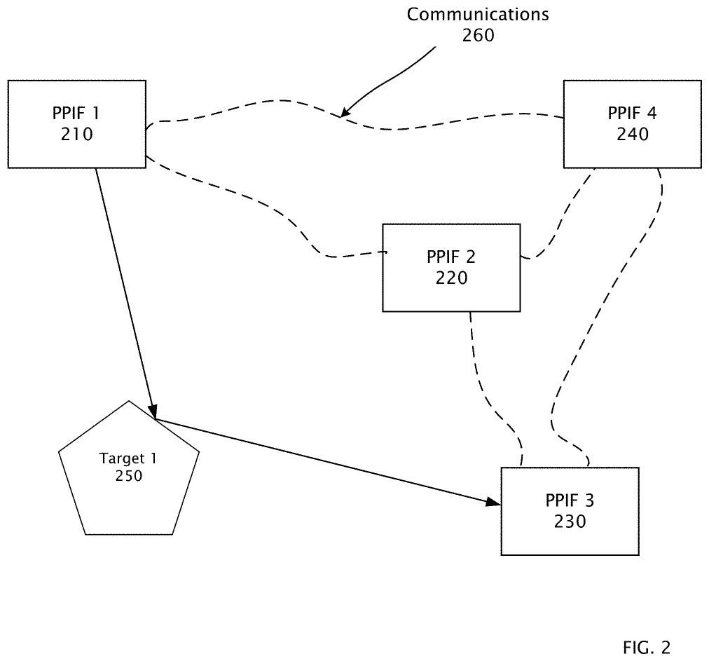

FIG. 2 illustrates PPIF units 210, 220, 230, 240 using Communications 260 to share sensor data, according to one implementation. In this example, PPIF 1 210 may project a beam, and because of the angle on Target 1 250, a majority of the beam may be deflected. Prior planning and prediction or observation of past attempts may position PPIF 3 230, or another sensor that is networked to the whole, to record and assess the emitter Target 1 250 interaction. This sensor data may create a 3D plus construction of the environment.

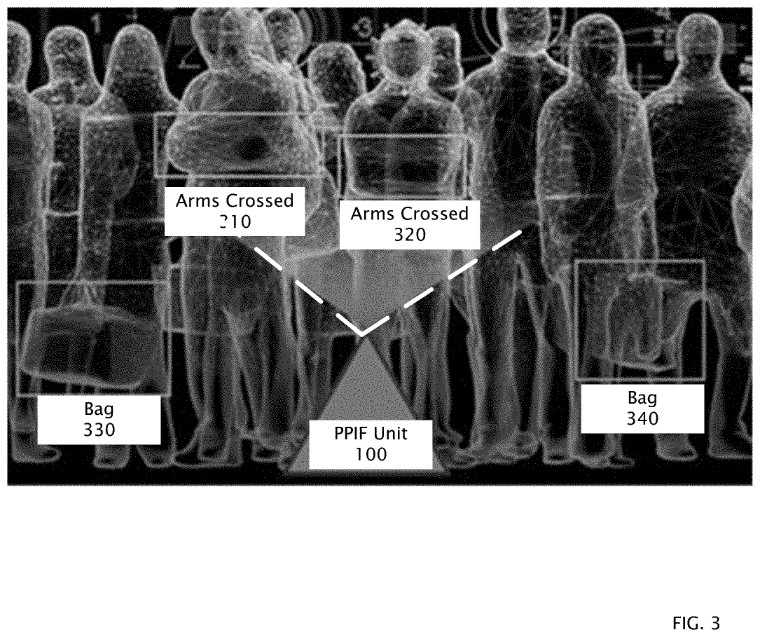

FIG. 3 illustrates PPIF Unit 100 in action. In this image, two people 310, 320 are classified as crossing their arms and two 330, 340 as carrying bags and thus may meet the experimental criteria for dazzling. PPIF Unit 100 may also detect security cameras and UASs, for example, which may be subject to higher laser dazzling intensity for suppression. The dashed lines indicate the raster scan target areas. After each scan, the laser may reset to run through another scan. Each scan sequence may be dynamically updated on-the-fly with tracking data from the optical camera to maintain dazzling on moving targets.

Raster scanning laser may have multiple raster path strategies that can be optimized based on the steering hardware, laser on/off ramping and response time, and required field of view coverage area.

The feedback system may use the sensors and effectors to test the environment against predictions and update the predictions to better represent the environment and outcome of future actions. This may continuously improve the perception and prediction of the system relay this information to the subsystems. Scanning patterns may be used as a method of differentiation. Some systems may use pulse rate or frequency as a way of determining if a laser is a correct laser to watch, such as a laser guided bomb. By varying the laser pattern in space, a further level of authentication can be imparted that would be much harder for jamming system to attempt to replicate. The motion of the laser is in effect a communication strategy.

PPIF Unit 100 may be designed to employ an emitter such as a laser and laser module in multiple modes, automatically adjusting to changing situations. It may be steered by a computer algorithm and may be informed by multiple other sensor systems. Current handheld laser dazzlers or disruption devices carried by humans and intended to dazzle humans are primarily handheld and require the user to aim them. The operator typically controls power, beam dispersion, and angle.

Past systems are dedicated and have a narrow-limited use. Examples would be a targeting laser to guide a munition, a dazzler to disrupt visual sensors, a survey/mapping tool/LIDAR, an acoustic/vibration sensor, a weather doppler sensor, a communication system, or a destructive system. If a laser is used for multiple uses, it is employed by a human. A handheld laser may be pointed to direct attention and signal, flashed in a pattern to send a message, pointed at optics to degrade observability, used as a reference point to aim or register something, or illuminate an area or target. All of these use a human, their intelligence, and attention. A human, although adaptable, is less precise and, in most instances, slower in reaction, for example, when communicating the derived information from observing the laser or adjusting that laser to the world. Although a human may want to align a laser to a far-off point, it takes significantly longer for a human to push, pull, or adjust settings to align the laser.

It may be useful to direct lasers or emitters from multiple points of view. This may, among other things, allow illuminating a target from another angle shaded by some other object. For example, if a person lowers their head and looks toward the ground, an eye-level laser would no longer be able to directly target the eye effectively, but if the system is communicating or working with multiple systems, then these new angles and perspectives could also be targeted and illuminated.

Accurately maneuvering a laser or emitter while controlling other behaviors and aspects, such as encoding rates, intensity, focus, wavelength, power or intensity, or coherence, allows abilities not currently found in real-world everyday encounters. An automatic aiming system that may rapidly adjust multiple settings and implement precise feedback from other sensor systems may allow many abilities that currently need skilled technicians and significant time to tune and set up.

By varying pulse, power, and wavelength, pseudo audio signals can be sent to a wide variety of MEMs microphones. A system that can automatically locate, target, and hit MEMS sensors in a dynamic environment may be useful for messaging friendly forces via a native microphone, bypassing security systems by mimicking a user's voice inputs, or spoofing command signals at a distance.

Spectroscopy laser, accurately directing a laser and guiding the laser via another sensor such as an RGB camera, may allow segmenting and understanding of what the laser is looking at. Variation in the beam intensity on the target may allow discerning the various signals and materials surrounding the target, which may allow the system to differentiate one signal from another. If the laser beam point is too large, nutating or sweeping the laser across the target may allow using only a portion of the edge of the beam impinging on the target.

By adjusting laser scan pattern dwell time and diffusion, a computer program may be used to highlight or look for items of interest. An operator may predefine illumination parameters around detected events. This could be used to show or spotlight items of interest or used to further investigate an object by creating more illumination of the item.

Dazzling, optics, cameras, thermals, eyes, and many other sensor types may be disrupted without the need for a human to manage the tracking and impingement in real-time. The user may preset parameters, and the optical and machine vision and computer can be utilized to direct a dazzler device, despite highly dynamic movement from the platform or the target or variations in the air/intervening medium.

By observing the variations in the return of a microphone laser, one can modulate the signal to derive audio and vibration signatures. This may be useful in creating listening devices on the fly from remote locations without installing equipment. A reference signal could be produced by one system with or without calibrated sensors specific to this generated signal. This generated signal may then be measured by the various sensors and used to calibrate the sensors in near real time. Given a dynamic environment where the sensor and emitters may change or the medium of interactions may change, the ability to update calibration may increase fidelity and prediction.

A LIDAR or LADAR point cloud may be obtained by varying the beam scan pattern and other aspects of the system. This may provide useful reflections from optical systems such as cameras and the back of animal eyeballs. Objects that meet a criteria threshold may further be illuminated and processed to discern additional data, i.e. areas of sufficient interest can be scanned longer and with more power or via other methods that would induce additional new data.

Illumination and sensor processing of an object may further provide additional details and properties of the object updated. This updated information can be used for tracking and prediction purposes. For example, a squirter may be highlighted by a visible laser, the person may remove or change clothing while attempting to evade detection. These changes can be updated and the objected tracked despite variations.

The foregoing disclosure provides illustration and description but is not intended to be exhaustive or limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting to the implementations. Thus, the operation and behavior of the systems or methods are described herein without reference to specific software code; software and hardware can be used to implement the systems or methods based on the description herein. As used herein, satisfying a threshold may, depending on the context, refer to a value being greater than the threshold, greater than or equal to the threshold, less than the threshold, less than or equal to the threshold, equal to the threshold, or the like, depending on the context. Although particular combinations of features are recited in the claims or disclosed in the specification, these combinations are not intended to limit the disclosure of various implementations. Many of these features may be combined in ways not explicitly recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, or the like) and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of.”

What is claimed is:

1. A device, comprising:
an emitter module;
a first optical train operably coupled to the emitter module;
a communications module, operably coupled to the emitter module;
a perception module, operably coupled to the emitter module;
an internal state module, operably coupled to the perception module; and
a modeling system module, operably coupled to the emitter module.

2. The device of claim 1, further comprising a second optical train module, operable coupled to the first optical train module.

3. The device of claim 1, further comprising a mapping module, operably coupled to the perception module.

4. The device of claim 1, further comprising additional sensors, operably coupled to the modeling system module.
